(19) United States
(12) Patent Application Publication
(10) Pub. No.: US 2019/0266290 A1
(43) Pub. Date: Aug. 29, 2019

(54) System and method for content delivery in a sustained multi-platform entertainment network

(71) Applicant: Michael Wolk, New York City, NY (US)

(72) Inventor: Michael Wolk, New York City, NY (US)

(21) Appl. No.: 15/906,377

(22) Filed: Feb. 27, 2018

(51) Int. Cl. G06F 17/30; G06Q 30/02

(52) U.S. Cl. CPC G06F 17/30873; G06F 17/30882; G06F 17/30017; G06Q 30/0277; G06F 17/30879

(57) ABSTRACT

A system and method are provided for creating an entertainment network that sustains one narrative across multiple media platforms. A pictorial representation of such a system is first displayed along with a plurality of components thereof. Next, information is presented relating to the interconnection of the different components of the system on the pictorial representation. The interconnectivity information relates more specifically to optional features of the components of the system that are available to consumers who are engaging with the system recreationally.

### FIELD OF THE INVENTION

This invention relates to a media system, components thereof and associated methods, specifically adapted for commercial use as a form of entertainment.

### BACKGROUND OF THE INVENTION

The last decade has seen an increase in immersive marketing, which is marketing where an entertainment company will create a virtual world for consumers to explore. For example, for the 2008 film The Dark Knight, the movie studio made a fake website for the Gotham City Police Department, so that movie fans could explore the fictional world of the film as though it were real, by looking around the website for clues about the Joker. And for the 2015 film Jurassic World, the movie studio made a fake corporate website for the fictional company that runs the dinosaur amusement park in the film, so that fans could again explore the fictional world as though it were real. Studios have even made fake social media accounts for fictional characters, so that fans can pretend to interact with their favorite characters on Facebook, Twitter, or the like. Then video-games like Pokémon Go developed this idea further, by allowing people to use their smartphones to earn virtual game points by interacting with real-world locations, hence blurring the line between virtual and real content.

The invention described in this application takes these concepts of immersive marketing and video-gaming, and presents a series of concrete mechanisms for delivering immersive content to text-based storytelling (including graphic novel storytelling): Consumers can read the text and images on their smartphones or other electronic devices, and then click on links that are embedded directly in that text in order to navigate to webpages that expand the fictional world of the story. A paper-printed version of this invention can, instead of hyperlinks, use barcodes in the text: QR barcodes can be scanned by smartphones, and once they are scanned they can trigger the smartphone to navigate to a certain webpage, just like clicking on a hyperlink. This mechanism will give print-version consumers a way to still explore the web content. Hence, this system sustains a single entertainment experience across multiple platforms, by hosting additional story content on these various platforms and providing methods by which consumers can navigate between these platforms in order to engage with all of this content.

Consumer interest in storytelling through electronic media has increased in recent years, wherein consumers prefer to engage with entertainment via computers and smartphones and e-book readers rather than printed books, and consumer expectations and demands have increased for more diverse forms of media engagement. Technology has also newly developed which allows for different printed and electronic media platforms to interconnect, such that a section of text or an image on an e-book reader could be hyperlinked to a webpage and so on, allowing consumers to navigate to different platforms within the same entertainment session, thereby following the same sustained narrative across multiple platforms.

Thus far, no entertainment experience has interconnected the same narrative across multiple platforms before. The technology to do so did not exist until approximately 2016: While multiple platforms existed, the interconnectivity aspect (such as being able to insert a reliable and functioning hyperlink into an e-book reader's text or into an image that is displayed among the sections of that text, wherein that hyperlink would bring the consumer to a related webpage) was not plausible until the most recent generation of electronic reading and communication devices. Entertainment experiences have, in the past, created separate narratives on different platforms with a degree of narrative continuity between platforms, but no previous entertainment experience has sustained the same single narrative across multiple platforms which are directly interconnected with active electronic hyperlinks or scannable barcodes that allow the consumer to navigate from one platform to another within the same user session. Moreover, the system and method for creating such a network of platforms—in a way that works reliably between various electronic and print devices—requires extensive coordination between platforms, and is therefore not apparent without technical knowledge.

### SUMMARY OF THE INVENTION

A system and method are provided for creating an entertainment network that sustains one narrative across multiple media platforms. A pictorial representation of such a system is first displayed along with a plurality of components thereof. Next, information is presented relating to the interconnection of the different components of the system on the pictorial representation. The interconnectivity information relates more specifically to optional features of the components of the system that are available to consumers who are engaging with the system recreationally.

In one aspect of the present invention, a quantity of electronic text or an image is imbued with an internet hyperlink, such that a consumer who is reading a story on a certain device can click on the hyperlink embedded in the text or image in order to navigate to a different section of the story which is hosted on a webpage, thereby exploring a different element of the same narrative sustained across multiple platforms. As an option, a plurality of webpages can be hyperlinked to each other such that a consumer who navigates from a reading device to a webpage can then proceed to other related webpages which contain further sections of the same sustained narrative.

In another aspect of the present invention, a quantity of physical text printed on paper is specially formatted with barcodes which allow the consumer to use a smartphone to navigate to webpages so that the consumer can still engage with additional sections of the narrative across multiple platforms.

### BRIEF DESCRIPTION OF DRAWINGS

FIG. 1 is a flowchart depicting a sample network between multiple media platforms wherein the same entertainment narrative is sustained from platform to platform.

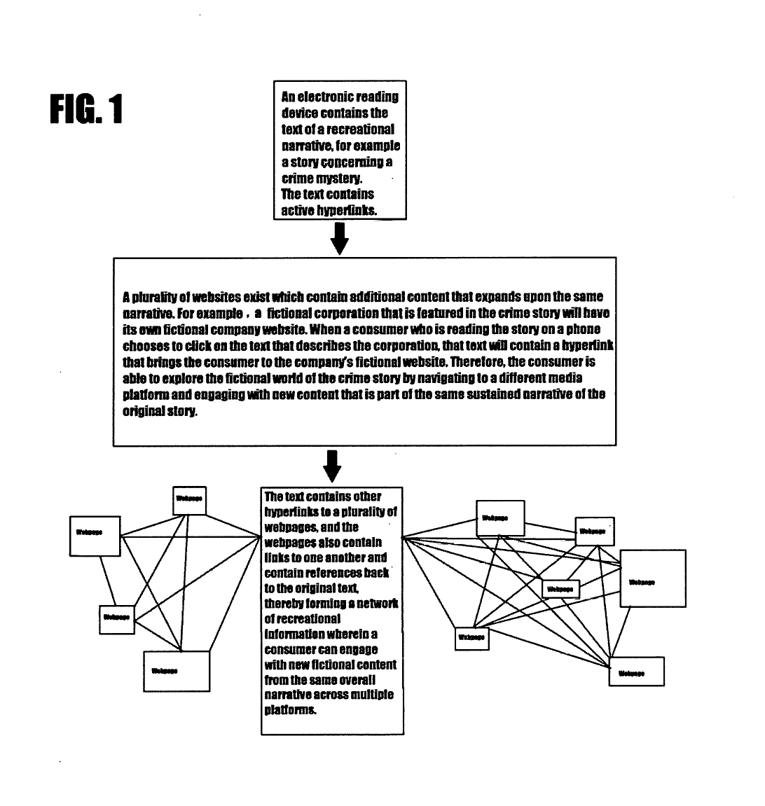

FIG. 2 is a flowchart depicting an alternative sample network between multiple media platforms wherein the same entertainment narrative is sustained from platform to platform.

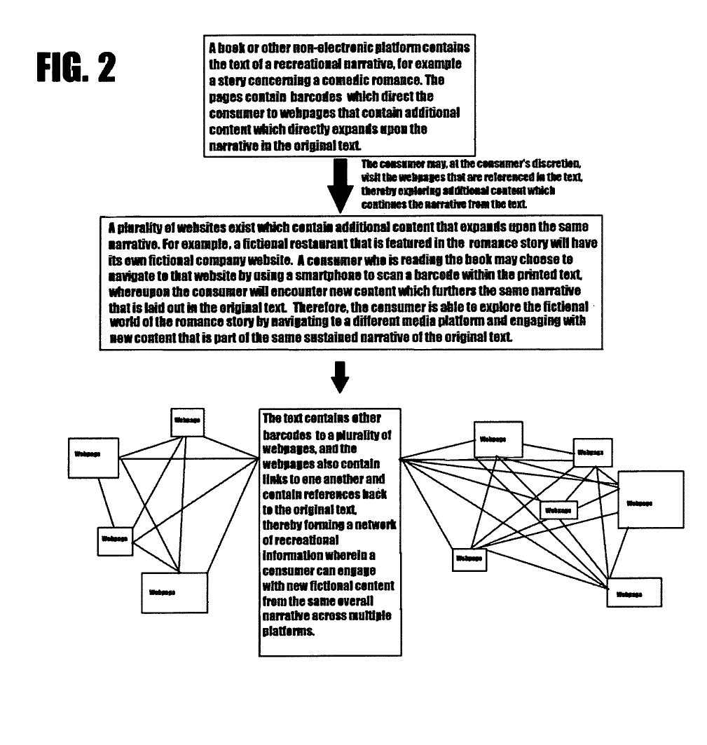

### DISCLOSURE OF THE INVENTION

The invention is constructed by first generating a fictional primary narrative in a printed or electronic textual medium, and then creating a plurality of webpages which extend the fictional content of the primary narrative by containing additional content that furthers the same plot points or character information that was presented in that primary narrative. Hyperlinks or barcodes, embedded directly within the text of the original primary narrative, allow the consumer to navigate between the primary narrative and the extended content that exists on other media platforms. Hence, the invention is a system consisting of three parts: A primary narrative, an extended narrative contained in webpage content, and internet hyperlinks or barcodes which connect these two aforementioned elements into a network whereby consumers may navigate to multiple media platforms in order to experience the same extended narrative across these different platforms.

### Usage of Terms

When used in this specification and claims and figures, the terms “include” and “including” and variations thereof mean that the specified features, steps or components are included. The terms are not to be interpreted to exclude the presence of other features, steps or components.

When used in this specification and claims and figures, “platform” refers to any physical object or device or non-physical presentation of data (such as a webpage) which can be used to convey information.

When used in this specification and claims and figures, “webpage” refers to a particular resource which exists under a single Uniform Resource Locator (URL) on the internet, while “website” refers to a collection of webpages that exist as subdivisions under a single internet domain name.

When used in this specification and claims and figures, “media” or “medium” refers to any system of communication by which sensory information can be conveyed to a consumer.

When used in this specification and claims and figures, “consumer” refers to any person or entity who is engaging with the invention. The intention of this invention is that consumers shall be paying customers engaging with the invention recreationally, but the definition is not limited solely to that scenario.

When used in this specification and claims and figures, “hyperlink” shall refer to any data that can directly navigate a consumer to a URL by clicking, tapping, or hovering over the electronic text or image that contains the navigational data.

When used in this specification and claims and figures, “barcode” or “OR barcode” shall refer to any optical, machine-readable representation of data.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A method for creating a single entertainment experience that is sustained across multiple media platforms, such that a consumer is able to follow the same narrative across printed publications, mobile communication devices, tablet computers, e-book readers, desktop computers, and laptop computers, where content is presented in the form of printed text, electronic text, internet hyperlinks, internet webpages, video images, still images, or sound, and where certain platforms add new content to the entertainment experience such that a consumer who interacts with multiple platforms will receive new narrative information that could not be received from interacting with any single platform, and where certain platforms direct the consumer to other platforms such that an interconnected network is formed where the consumer can experience different facets of the same fictitious scenario by exploring the different platforms.

2. The method of claim 1 where the electronic platforms are interconnected by a plurality of hyperlinks.

3. A method of claim 2 where a section of electronic text displayed on a mobile communication device, or a still image or video image embedded within that text, contains a hyperlink to a webpage that contains new content which extends the same narrative that was contained within the text that was displayed on the mobile communication device.

4. A method of claim 3 where the webpage that is the destination of a particular hyperlink also contains hyperlinks to additional webpages which also contain new content that extends the same narrative.

5. A method of claim 2 where a section of electronic text displayed on an e-book reader, or a still image or video image embedded within that text, contains hyperlinks to a webpage that contains new content which extends the same narrative that was contained within the text that was displayed on the e-book reader.

6. A method of claim 5 where the webpage that is the destination of a particular hyperlink also contains hyperlinks to additional webpages which also contain new content that extends the same narrative.

7. A method of claim 2 where a section of electronic text displayed on a desktop computer, or a still image or video image embedded within that text, contains hyperlinks to a webpage that contains new content which extends the same narrative that was contained within the text that was displayed on the computer.

8. A method of claim 7 where the webpage that is the destination of a particular hyperlink also contains hyperlinks to additional webpages which also contain new content that extends the same narrative.

9. A method of claim 2 where a section of electronic text displayed on a laptop computer, or a still image or video image embedded within that text, contains hyperlinks to a webpage that contains new content which extends the same narrative that was contained within the text that was displayed on the computer.

10. A method of claim 9 where the webpage that is the destination of a particular hyperlink also contains hyperlinks to additional webpages which also contain new content that extends the same narrative.

11. A method of claim 2 where a section of electronic text displayed on a tablet computer, or a still image or video image embedded within that text, contains hyperlinks to a webpage that contains new content which extends the same narrative that was contained within the text that was displayed on the computer.

12. A method of claim 11 where the webpage that is the destination of a particular hyperlink also contains hyperlinks to additional webpages which also contain new content that extends the same narrative.

13. A method of claim 1 where printed text in a paper publication contains a barcode that a consumer can scan with a mobile device in order to navigate to a webpage that contains new content which extends the same narrative that was contained within the publication.

14. A method of claim 13 where the webpage that is the destination of a particular barcode also contains hyperlinks to additional webpages which also contain new content that extends the same narrative.

15. A method of claim 1 where a particular webpage in the network can be accessed not only through a hyperlink in a section of electronic text or a hyperlink in an image or a barcode in printed text, but also accessed through standard internet navigation such as via a search engine inquiry or a direct input of the appropriate URL into a browser's navigation bar.

16. A method of claim 15 where a particular webpage contains written instructions which inform consumers how to find the printed publication or electronic text file that contains the primary narrative which that webpage extends, such that a consumer can navigate to the webpage before ever reading the publication or electronic text file and can then subsequently navigate from the webpage to the publication or electronic text file.
